(19) United States
(12) Patent Application Publication
(10) Pub. No.: US 2012/0175486 A1
(43) Pub. Date: Jul. 12, 2012

(54) ADJUSTABLE PANEL MOUNT AND METHOD FOR MAKING THE SAME

(76) Inventor: David Wayne Gotter, Brighton, IL (US)

(21) Appl. No.: 13/347,771

(22) Filed: Jan. 11, 2012

Related U.S. Application Data
(60) Provisional application No. 61/431,945, filed on Jan. 12, 2011.

(51) Int. Cl. F16M 11/00; B23P 11/00; F16M 13/00

(52) U.S. Cl. 248/398; 248/176.3; 29/428

(57) ABSTRACT

A panel mount includes a support structure, a strongback coupled to the support structure, and an adjustment assembly coupled between the strongback and the support structure. The adjustment assembly includes a lift mechanism configured to adjust an angle between the strongback and the support structure.

### CROSS REFERENCE TO RELATED APPLICATIONS

This application claims the priority of U.S. Provisional Patent Application Ser. No. 61/431,945, filed Jan. 12, 2011, which is hereby incorporated by reference in its entirety.

### BACKGROUND OF THE INVENTION

The field of the invention relates generally to panel mounts and, more particularly, to an adjustable panel mount for use with a solar panel.

At least some known panel mounts that are used with solar panels include a rack for supporting the solar panels. The rack includes cross beams having a plurality of bolt holes defined therethrough. To adjust an angle of the rack, a user selects at least one bolt holes, and inserts a bolt through the at least one bolt holes from an underneath side of the rack. Although such a rack is adjustable, it may be difficult for the user to maintain a position of the rack while inserting the bolt and/or for the user to access the bolt holes.

### BRIEF DESCRIPTION OF THE INVENTION

In one aspect, a panel mount is provided. The panel mount includes a support structure, a strongback coupled to the support structure, and an adjustment assembly coupled between the strongback and the support structure. The adjustment assembly includes a lift mechanism configured to adjust an angle between the strongback and the support structure.

In another aspect, a panel assembly is provided. The panel assembly includes a support structure, at least one panel, and a panel mount coupled to the support structure and configured to support the at least one panel. The panel mount includes a support grid coupled to the at least one panel, a strongback coupled to the support grid, and an adjustment assembly coupled between the strongback and the support structure. The adjustment assembly includes a lift mechanism configured to adjust an angle between the strongback and the support structure.

In yet another aspect, a method for making a panel mount is provided. The method includes coupling a support grid to a strongback, coupling the strongback to a mounting sleeve via a pivot bar, and rotatably coupling a lift assembly to the mounting sleeve and the strongback. The lift mechanism is configured to adjust an angle between the strongback and the mounting sleeve.

### BRIEF DESCRIPTION OF THE DRAWINGS

FIG. 1 is a top perspective view of an exemplary panel assembly.

FIG. 2 is a top perspective view of an exemplary panel mount that may be used with the panel assembly shown in FIG. 1.

FIG. 3 is a top view of the panel mount shown in FIG. 2.

FIG. 4 is a side view of the panel mount shown in FIG. 2.

FIG. 5 is an end view of the panel mount shown in FIG. 2.

FIG. 6 is a bottom perspective view of the panel mount shown in FIG. 1.

FIG. 7 is a side view of an exemplary adjustment assembly that may be used with the panel mount shown in FIGS. 2-6.

FIG. 8 is a side view of an exemplary gauge that may be used with the panel assembly shown in FIGS. 1-7.

### DETAILED DESCRIPTION OF THE INVENTION

The embodiments described herein include a lift mechanism for adjusting an angular position of a solar panel with respect to a support structure. The lift mechanism includes a crank that is used to rotate the panel about a horizontal axis defined at an attachment point to the support structure. As such, a user does not remove bolts to readjust an angle of the solar panels. Rather, the user adjusts the angle of the solar panels using the crank.

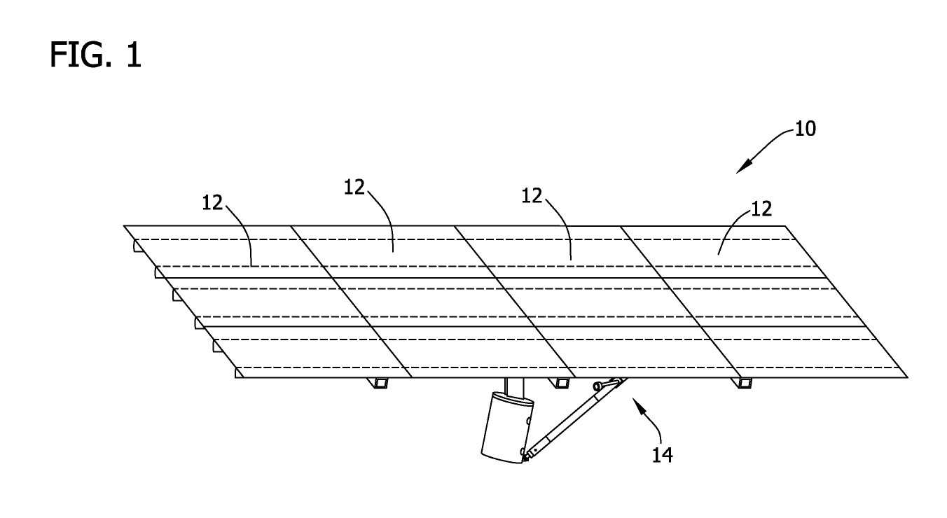

FIG. 1 is a top perspective view of an exemplary panel assembly 10. In the exemplary embodiment, panel assembly 10 includes at least one panel 12, such as a solar panel, and a panel mount 14. Panel 12 is coupled to panel mount 14, and panel mount 14 supports panel 12 at a predetermined position, as described in more detail herein. In the exemplary embodiment, panel mount 14 is adjustable to a plurality of angles to enable panel 12 to be properly positioned for absorbing radiation from the sun. Further, in the exemplary embodiment, panel mount 14 is a top pole mounting system; however, it should be understood that panel mount 14 can support panel 12 on any suitable support structure.

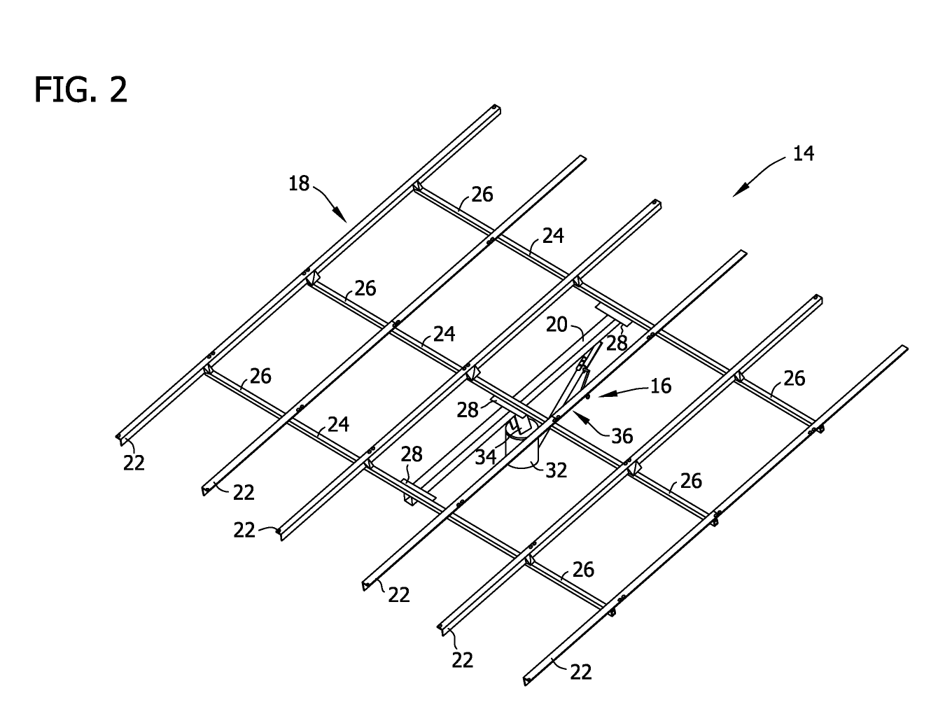

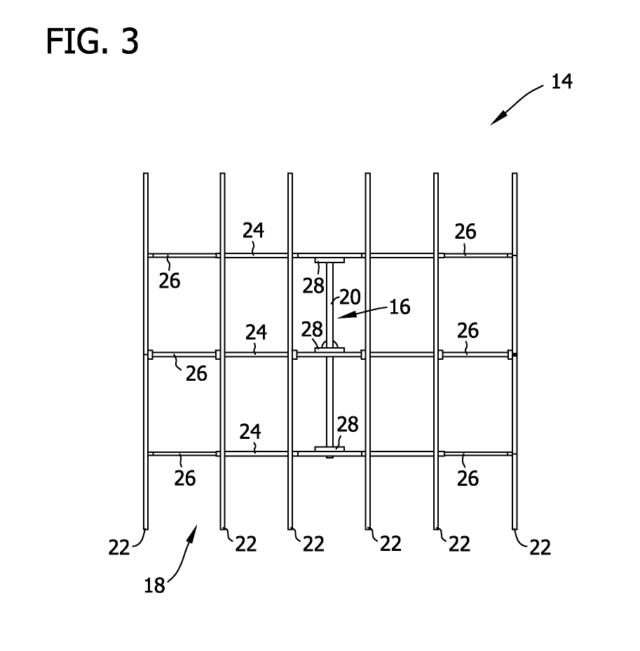

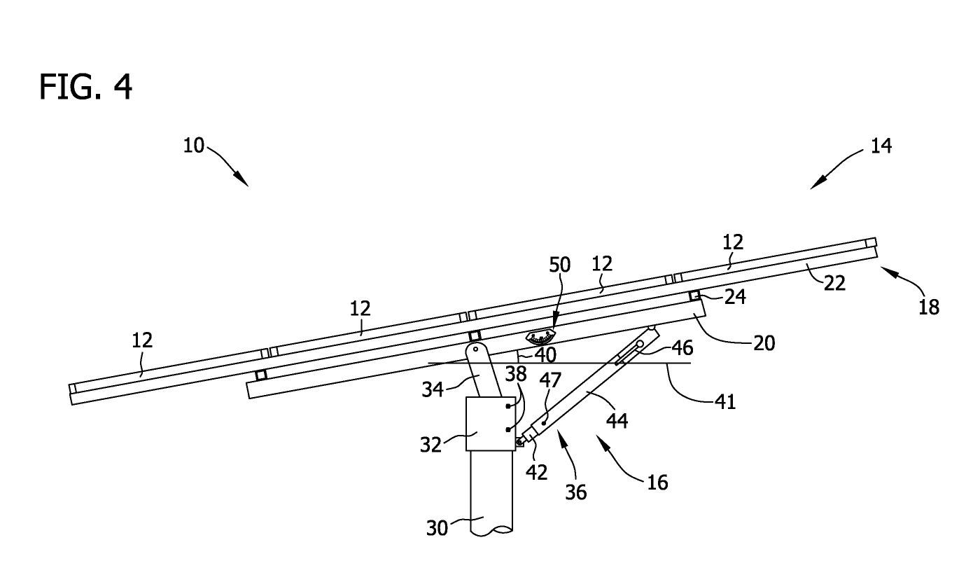

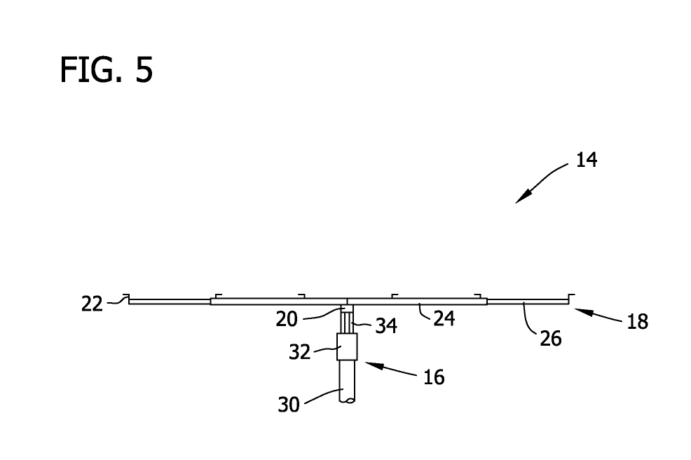

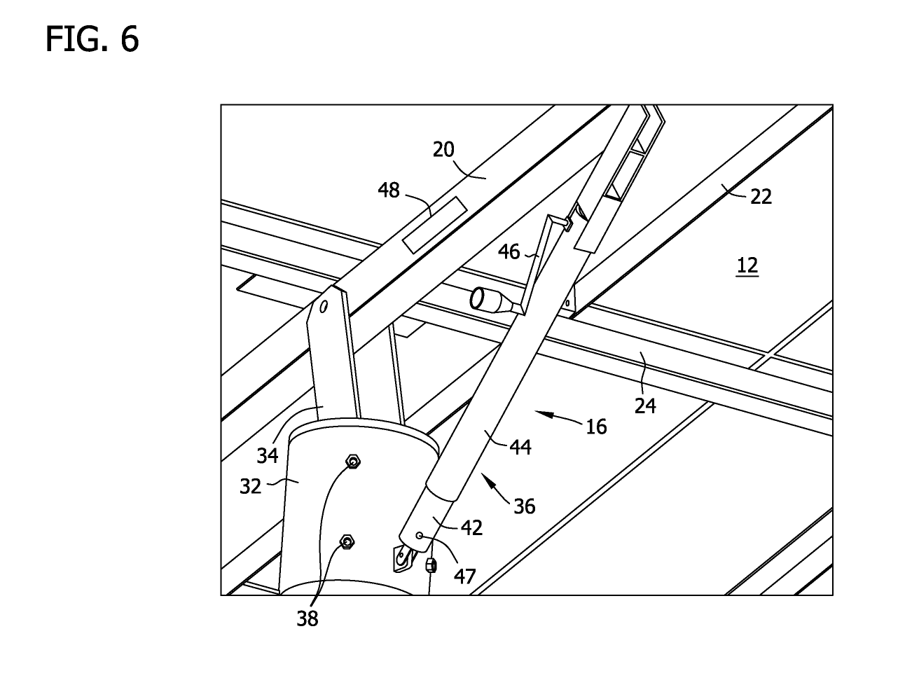

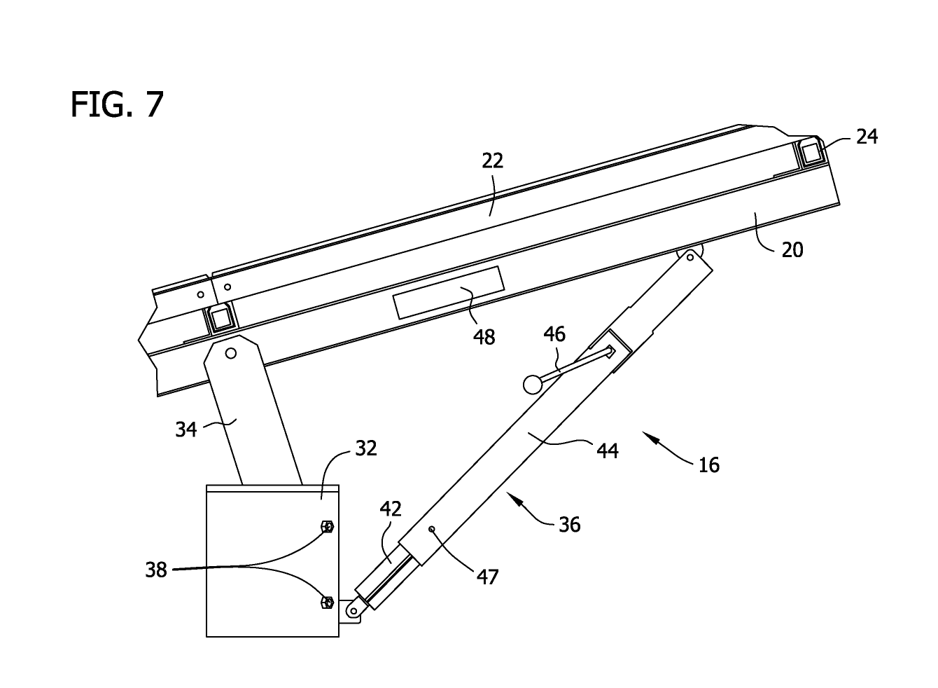

FIG. 2 is a top perspective view of an exemplary panel mount 14 that may be used with panel assembly 10 (shown in FIG. 1). FIG. 3 is a top view of panel mount 14. FIG. 4 is a side view of panel mount 14. FIG. 5 is an end view of panel mount 14. FIG. 6 is a bottom perspective view of panel mount 14. FIG. 7 is a side view of an exemplary adjustment assembly 16 that may be used with panel mount 14.

In the exemplary embodiment, panel mount 14 includes a support grid 18, a strongback 20, and adjustment assembly 16. Support grid 18 includes a plurality of module rails 22 and a plurality of crossbars 24. Module rails 22 are substantially parallel to each other and substantially perpendicular to crossbars 24. As such, module rails 22 and crossbars 24 define support grid 18. Module rails 22 are configured for coupling to at least one panel 12 (shown in FIG. 1). For example, module rails 22 can be angled metal rails configured to couple to panel 12, and crossbars 24 can be metal tubing coupled to module rails 22. In the exemplary embodiment, crossbar extensions 26 extend from ends of crossbars 24 to enable panel mount 14 to support more than one row of panels 12. At least one module rail 22 is coupled to crossbar extensions 26 to support an additional row of panels. Module rails 22 are substantially perpendicular with respect to crossbar extensions 26. Although module rails 22 are described herein as being substantially perpendicular to crossbars 24 and crossbar extensions 26, it should be understood that module rails 22, crossbars 24, and/or crossbar extensions 26 can have any suitable orientations with respect to each other.

Support grid 18 is coupled to strongback 20 such that crossbars 24 are substantially perpendicular to strongback 20. Alternatively, crossbars 24 are at any suitable orientation with respect to strongback 20. In the exemplary embodiment, crossbars 24 are coupled to strongback 20, and module rails 22 are coupled to crossbars 24. Strongback 20 is configured to support crossbars 24 having module rails 22 attached thereto. Strongback 20 may be formed from metal tubing that is larger than the metal tubing used to form crossbars 24. Supports 28 are coupled to strongback 20 and crossbars 24 to provide further support to crossbars 24 and/or strongback 20. Alternatively, supports 28 are omitted. In the exemplary embodiment, adjustment assembly 16 is coupled between strongback 20 and a support structure, such as a pole 30.

Adjustment assembly 16 includes a mounting sleeve 32, a pivot bar 34, and a lift mechanism 36. Mounting sleeve 32 is coupled to a top of pole 30 and is configured to enable panel mount 14 to be supported on pole 30. In the exemplary embodiment, mounting sleeve 32 is configured receive pole 30 therein and, as such, has a geometry substantially similar to the top of pole 30. Alternatively, mounting sleeve 32 is inserted into pole 30 and/or otherwise coupled to pole 30. In the exemplary embodiment, mounting sleeve 32 is coupled to pole 30 using removable fasteners 38. By loosening and/or removing fasteners 38, panel mount 14 can be rotated with respect to pole 30 to position panel 12 at a rotational position.

Pivot bar 34 is fixedly coupled to strongback 20 and rotatably coupled to mounting sleeve 32 such that pivot bar 34 is pivotable with respect to mounting sleeve 32. Alternatively, pivot bar 34 is rotatably coupled to strongback 20 and/or fixedly coupled to mounting sleeve 32. In the exemplary embodiment, pivot bar 34 is configured to enable an angle 40 (shown in FIG. 4) between a plane 41 at 0° and strongback 20 to be adjusted, as described herein. For example, angle 40 is adjustable between about 10° and about 80°.

Lift mechanism 36 is coupled to mounting sleeve 32 and strongback 20 for adjusting angle 40. In the exemplary embodiment, lift mechanism 36 is rotatably coupled to mounting sleeve 32 and strongback 20 such that lift mechanism 36 pivots with respect to strongback 20 and mounting sleeve 32 as angle 40 is adjusted. Lift mechanism 36 includes a first portion 42, a second portion 44, and a crank 46. First portion 42 is coupled to mounting sleeve 32, and second portion 44 is coupled to strongback 20. First portion 42 is positioned within second portion 44 and is configured to move into and out of second portion 44 using crank 46. As such, crank 46 is configured to extend or retract first portion 42 with respect to second portion 44. Accordingly, a length of lift mechanism 36 is adjustable using crank 46. The length of lift mechanism 36 is selected to achieve a desired angle 40. For example, angle 40 is decreased by shortening lift mechanism 36, and angle 40 is increased by lengthening lift mechanism 36.

In the exemplary embodiment, crank 46 is a manually operable hand-crank to reduce energy used by lift mechanism 36 and/or simplify maintenance of lift mechanism 36; however, it should be understood that lift mechanism 36 can include a motor for manual and/or automatic adjustment thereof. In the exemplary embodiment, a set screw 47 is configured to maintain a selected length of lift mechanism 36. More specifically, set screw 47 is at least partially coupled to second portion 44 and is configured to apply a force to first portion 42 for maintaining the length of lift mechanism 36. In an alternative embodiment, lift mechanism 36 includes any suitable mechanism and/or device for maintaining a selected length of lift mechanism 36.

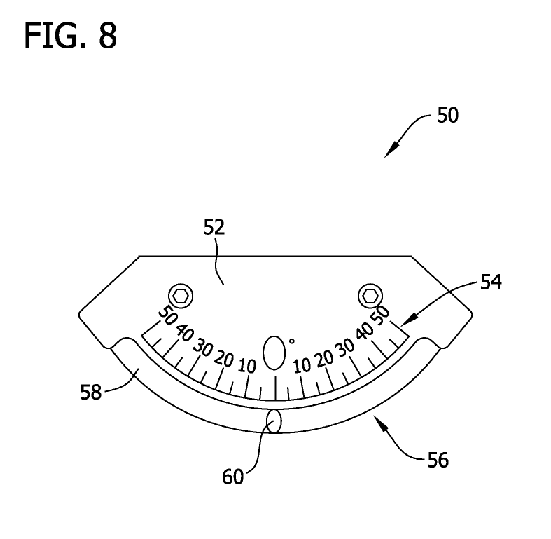

In a particular embodiment, a gauge 48 is coupled to strongback 20 to indicate angle 40. For example, as lift mechanism 36 is operated, gauge 48 variably indicates angle 40. FIG. 8 is a side view of an exemplary gauge 50 that may be used as gauge 48. In the exemplary embodiment, gauge 50 includes a body 52, angle labels 54, and an indicator assembly 56. Body 52 is coupled to strongback 20 and/or any other suitable component of panel assembly 10. Angle labels 54 are defined on body 52 adjacent indicator assembly 56. Indicator assembly 56 is configured to move as angle 40 is varied. In one embodiment, indicator assembly 56 includes a fluid-filled transparent tube 58 having an indicator 60 floating therein. As such, when angle 40 changes, indicator 60 moves through the tube 58 to indicate a value of angle 40 along angle labels 54. Alternatively, panel assembly 10 includes any suitable gauge 48 that enables panel assembly 10 to function as described herein.

Referring to FIGS. 1-7, to make panel assembly 10, crossbars 24 are coupled to strongback 20. Supports 28 are coupled to crossbars 24 and strongback 20. Module rails 22 are coupled to crossbars 24 to form support grid 18. Panel 12 is coupled to module rails 22. When panel assembly 10 includes more than one row of panels 12, crossbar extensions 26 are coupled to crossbars 24, and module rails 22 are coupled to crossbars 24 and crossbar extensions 26 to form support grid 18. Panels 12 are coupled to module rails 22.

Adjustment assembly 16 is coupled to strongback 20. More specifically, pivot bar 34 is coupled to strongback 20 and mounting sleeve 32. Lift mechanism 36 is coupled to strongback 20 and mounting sleeve 32 by coupling first portion 42 to mounting sleeve 32, coupling second portion 44 to strongback 20, and inserting first portion 42 into second portion 44. Alternatively, second portion 44 is inserted into first portion 42. In the exemplary embodiment, crank 46 is coupled to first portion 42 and/or second portion 44. Gauge 48 is also coupled to strongback 20. Mounting sleeve 32 is coupled to pole 30 and fasteners 38 are tightened when panel 12 is at a desirable position. Lift mechanism 36 is adjusted as described herein.

Referring to FIGS. 1-7, during use of panel assembly 10, panel 12 is positioned to receive radiation from the sun. More specifically, panel mount 14 is rotated about pole 30 at mounting sleeve 32 to adjust a rotational position of panel 12, and fasteners 38 are tightened to lock the rotational position. Further, crank 46 is used to extend or retract first portion 42 with respect to second portion 44 to position panel 12 at a predetermined angle 40 with respect to pole 30 to enable panel 12 to receive radiation. More specifically, an operator accesses crank 46 from underneath panel 12. As the operator rotates crank 46, angle 40 is adjusted as indicated on gauge 48. When panel 12 is oriented at a desired angle 40, the operator discontinues operation of crank 46. Set screw 47 is then tightened to secure lift assembly 36 at the selected length and/or selected value of angle 40.

In one aspect, a panel mount is provided. The panel mount includes a support grid coupled to a strongback. The strongback is mounted to a support structure. An adjustment assembly is coupled between the strongback and the support structure. The adjustment assembly includes a lift mechanism configured to adjust an angle between the strongback and the support structure.

In another aspect, a panel assembly is provided. The panel assembly includes a panel and a panel mount to which the panel is coupled. The panel mount includes a support grid coupled to a strongback. The strongback is mounted to a support structure. An adjustment assembly is coupled between the strongback and the support structure. The adjustment assembly includes a lift mechanism configured to adjust an angle between the panel and the support structure.

The above-described embodiments provide an adjustment assembly for adjusting an angle of a panel with respect to a pole on which the panel is mounted. The lift mechanism described herein is easily operable by a user to change the angle of the panel, as compared to panel mounts having a plurality of bolt holes. As such, the angle of the panel can be adjusted to several angles over a time period to optimize an amount of radiation received by the panel. Further, the panel mount described herein is expandable to support more than one row of panels using the crossbar extensions.

Exemplary embodiments of an adjustable panel mount are described above in detail. The methods and apparatus are not limited to the specific embodiments described herein, but rather, components of the apparatus and/or steps of the methods may be utilized independently and separately from other components and/or steps described herein. Rather, the exemplary embodiment can be implemented and utilized in connection with many other panel applications, and is not limited to the solar panels described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A panel mount comprises:
a support structure;
a strongback coupled to said support structure; and
an adjustment assembly coupled between said strongback and said support structure, said adjustment assembly comprises a lift mechanism configured to adjust an angle between said strongback and said support structure.

2. A panel mount in accordance with claim 1 further comprising a support grid coupled to said strongback, wherein said support grid is configured to support at least one panel.

3. A panel mount in accordance with claim 2, wherein said support grid comprises a plurality of module rails and a plurality of crossbars coupled to said plurality of module rails.

4. A panel mount in accordance with claim 3, wherein each module rail of said plurality of module rails comprises an angled metal rail configured to couple the at least one panel thereto.

5. A panel mount in accordance with claim 3, wherein said support grid further comprises a plurality of crossbar extensions extending from a respective crossbar of said plurality of crossbars.

6. A panel mount in accordance with claim 3, wherein said plurality of crossbars are coupled to said strongback.

7. A panel mount in accordance with claim 1, wherein said lift mechanism comprises a first portion, a second portion, and a crank configured to move said first portion and said second portion relative to each other to adjust a length of said lift mechanism.

8. A panel mount in accordance with claim 7, wherein said lift mechanism further comprises a set screw configured to maintain a selected length of said lift mechanism.

9. A panel mount in accordance with claim 1, wherein said adjustment assembly further comprises a mounting sleeve coupled to said support structure, said mounting sleeve configured to support said panel mount on said support structure.

10. A panel mount in accordance with claim 9, wherein said adjustment assembly further comprises a pivot bar rotatably coupled to at least one of said mounting sleeve and said strongback.

11. A panel mount in accordance with claim 9, wherein said lift mechanism is rotatably coupled to said mounting sleeve and rotatably coupled to said strongback.

12. A panel mount in accordance with claim 1 further comprises a gauge coupled to said strongback and configured to indicate the angle.

13. A panel assembly comprises:
a support structure;
at least one panel; and
a panel mount coupled to said support structure and configured to support said at least one panel, said panel mount comprises:
a support grid coupled to said at least one panel;
a strongback coupled to said support grid; and
an adjustment assembly coupled between said strongback and said support structure, said adjustment assembly comprises a lift mechanism configured to adjust an angle between said strongback and said support structure.

14. A panel assembly in accordance with claim 13, wherein said panel comprises a solar panel.

15. A panel assembly in accordance with claim 13, wherein said support grid comprises a plurality of module rails and a plurality of crossbars coupled to said plurality of module rails, each module rail of said plurality of module rails comprising an angled metal rail configured to couple the at least one panel thereto, said plurality of crossbars coupled to said strongback.

16. A panel assembly in accordance with claim 15, wherein said support grid further comprises a plurality of crossbar extensions extending from a respective crossbar of said plurality of crossbars.

17. A panel assembly in accordance with claim 13, wherein said adjustment assembly further comprises:
a mounting sleeve coupled to said support structure, said mounting sleeve configured to support said panel mount on said support structure, wherein said lift mechanism is rotatably coupled to said mounting sleeve and rotatably coupled to said strongback; and
a pivot bar rotatably coupled to at least one of said mounting sleeve and said strongback.

18. A panel assembly in accordance with claim 13, wherein said lift mechanism comprises a crank configured to adjust a length of said lift mechanism.

19. A panel assembly in accordance with claim 18, wherein said lift mechanism comprises a first portion and a second portion, said crank configured to move said first portion and said second portion relative to each other to adjust the length of said lift mechanism.

20. A method for making a panel mount, said method comprising:
coupling a support grid to a strongback;
coupling the strongback to a mounting sleeve via a pivot bar; and
rotatably coupling a lift assembly to the mounting sleeve and the strongback, the lift mechanism configured to adjust an angle between the strongback and the mounting sleeve.
